(19) United States
(12) Patent Application Publication
(10) Pub. No.: US 2019/0195347 A1
(43) Pub. Date: Jun. 27, 2019

(54) ELECTRIC OIL PUMP AND METHOD FOR MAKING ELECTRIC OIL PUMP

(71) Applicant: NIDEC TOSOK CORPORATION, Kanagawa (JP)

(72) Inventors: Shigehiro KATAOKA, Kanagawa (JP); Yoshiyuki KOBAYASHI, Kanagawa (JP)

(73) Assignee: NIDEC TOSOK CORPORATION, Kanagawa (JP)

(21) Appl. No.: 16/218,499

(22) Filed: Dec. 13, 2018

(30) Foreign Application Priority Data
Dec. 21, 2017 (JP) 2017-245619

(51) Int. Cl. F16H 61/00; F16H 57/04; F04B 17/03

(52) U.S. Cl. CPC F16H 61/0031; F16H 57/0436; F16H 2061/0037; F04B 17/03; F16H 57/0446

(57) ABSTRACT

An electric oil pump includes a motor part having a shaft; and a pump part that is driven by the motor part via the shaft and discharges oil. The motor part includes a rotor, a stator disposed to face the rotor, a coil provided in the stator, and a motor housing having a cylindrical part in which the rotor and the stator are accommodated. The pump part includes a pump rotor attached to the shaft and a pump housing having a housing part in which the pump rotor is accommodated. The motor housing includes a bearing that supports the shaft, a tubular bearing housing that holds the bearing, and a bus bar assembly connected to a coil end of the coil that extends from the stator. In this feature, the stator, the bus bar assembly, and the bearing housing are sequentially disposed from the pump part to the motor part.

### CROSS REFERENCE TO RELATED APPLICATIONS

The present application claims priority under 35 U.S.C. § 119 to Japanese Patent Application No. 2017-245619 filed on Dec. 21, 2017. The entire content of which is incorporated herein by reference.

### BACKGROUND

### Technical Field

The disclosure relates to an electric oil pump and a method of producing an electric oil pump.

### Description of Related Art

An electric oil pump having a structure including a pump part, a motor part configured to drive the pump part, and a control part configured to control an operation of the motor part is known. In this electric oil pump, the pump part is disposed on one side of the motor part in the axial direction and a shaft that extends from the motor part penetrates a pump body of the pump part. On one side end surface of the pump body in the axial direction, a housing part in which one side is open in the axial direction of the pump body and the other side in the axial direction is recessed is provided. A pump rotor is accommodated in the housing part. In addition, the control part has a board on which electronic components that drive the motor part are mounted.

In the structure of the related art, a board and a control circuit part that control an operation of the motor part are disposed on the other side with respect to the motor part in the axial direction in many cases. The control circuit part includes electronic components such as an inverter circuit, a microcomputer, a coil, and a capacitor, and the electronic components may be mounted on both surfaces of the board.

In the electric oil pump, since the motor part and the pump part are linearly disposed in the axial direction, the length in the axial direction increases. In the electric oil pump device of the related art, the board is disposed to extend in a direction orthogonal to the axial direction, but the electronic components are mounted on the board and protrude to the other side in the axial direction. In addition, the board and the electronic components are covered with a cover. The cover is attached to the other side end of the motor part in the axial direction and disposed to protrude to the other side in the axial direction with respect to the board and the electronic component. Therefore, the electric oil pump device of the related art increases in length in the axial direction and increases in size.

On the other hand, for example, in electric oil pumps applied to vehicles, there is strong demand for downsizing for securing minimum ground clearance for the vehicles. Therefore, it is desirable to provide an electric oil pump which has a board on which electronic components are mounted and is reduced in size in the axial direction.

### SUMMARY

According to an exemplary embodiment of the disclosure, there is provided an electric oil pump including a motor part having a shaft disposed along a central axis that extends in an axial direction; and a pump part that is positioned on one side of the motor part in the axial direction and is driven by the motor part via the shaft and discharges oil. The motor part includes a rotor fixed to the other side of the shaft in the axial direction, a stator disposed to face the rotor, a coil provided in the stator, and a motor housing having a cylindrical part in which the rotor and the stator are accommodated. The pump part includes a pump rotor attached to the shaft that protrudes from the motor part to one side in the axial direction and a pump housing having a housing part in which the pump rotor is accommodated. The motor housing includes a bearing that supports the shaft that protrudes from the motor part to the other side in the axial direction, a tubular bearing housing that holds the bearing, and a bus bar assembly connected to a coil end of the coil that extends from the stator. The stator, the bus bar assembly, and the bearing housing are sequentially disposed from the pump part to the motor part.

In a production method in the above embodiment, there is provided a method of producing an electric oil pump including a motor part having a shaft disposed along a central axis that extends in an axial direction; and a pump part that is positioned on one side of the motor part in the axial direction and is driven by the motor part via the shaft and discharges oil. The motor part includes a rotor fixed to the other side of the shaft in the axial direction, a stator disposed to face the rotor, a coil provided in the stator, and a motor housing in which the rotor and the stator are accommodated. The motor housing includes a bearing that supports the shaft that protrudes from the motor part to the other side in the axial direction, a tubular bearing housing that holds the bearing, and a bus bar assembly connected to a coil end of the coil that extends from the stator. The method includes a stator press-fitting process in which the stator is press-fitted into the motor housing from the other side of the motor housing in the axial direction; a bus bar assembly insertion process in which the bus bar assembly is inserted into the motor housing from the other side of the motor housing in the axial direction and the bus bar assembly is disposed near the stator; a coil connection process in which a coil end of the coil is electrically connected to a connecting bus bar of the bus bar assembly; a bearing housing press-fitting process in which the bearing housing is press-fitted into the motor housing from the other side of the motor housing in the axial direction; and a bus bar assembly fixing process in which the bearing housing is fixed to the bus bar assembly through a fixing member.

The above and other elements, features, steps, characteristics and advantages of the present disclosure will become more apparent from the following detailed description of the exemplary embodiments with reference to the attached drawings.

### BRIEF DESCRIPTION OF THE DRAWINGS

FIG. 1 is a cross-sectional view of an electric oil pump according to a first embodiment.

FIG. 2 is a plan view of the electric oil pump in which illustration of a board cover is omitted.

FIG. 3 is a cross-sectional view of the electric oil pump taken along the arrow II-II in

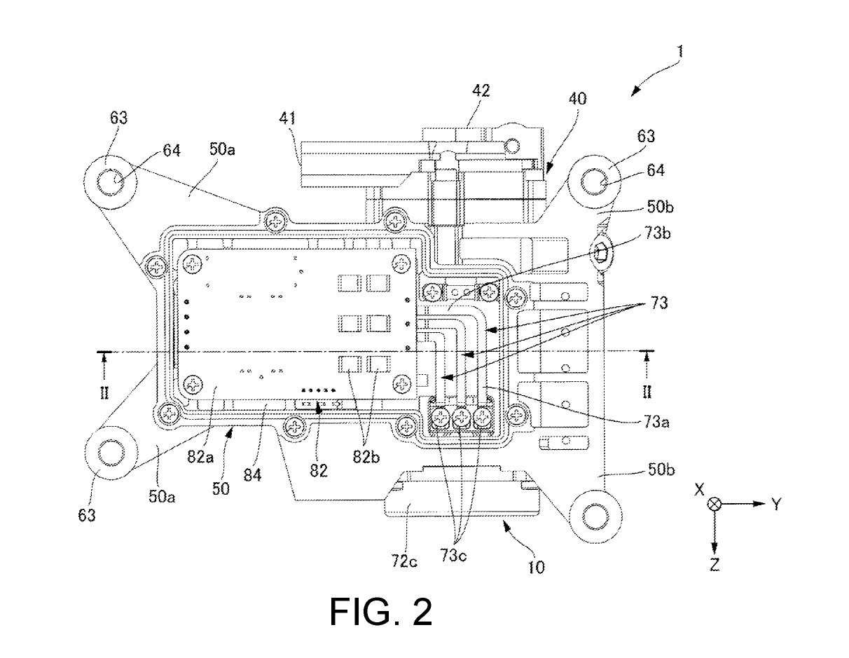

FIG. 2.

FIG. 4 is a perspective view of a bearing housing.

FIG. 5 is a perspective view of an internal structure of the electric oil pump when viewed from the motor part side.

FIG. 6 is an internal structure view of a bus bar assembly in which an assembly main body is omitted.

FIG. 7 is a perspective view of the assembly main body of the bus bar assembly.

### DESCRIPTION OF THE EMBODIMENTS

The disclosure is to provide an electric oil pump which has a board and is reduced in size in an axial direction and a method of producing an electric oil pump.

An electric oil pump and a method of producing an electric oil pump according to embodiments of the disclosure will be described below with reference to the drawings. In the present embodiment, an electric oil pump configured to supply oil to a transmission mounted on a vehicle such as an automobile will be described. In addition, in the following drawings, in order to allow respective configurations to be easily understood, actual structures and scales and numbers in the structures may be different therefrom.

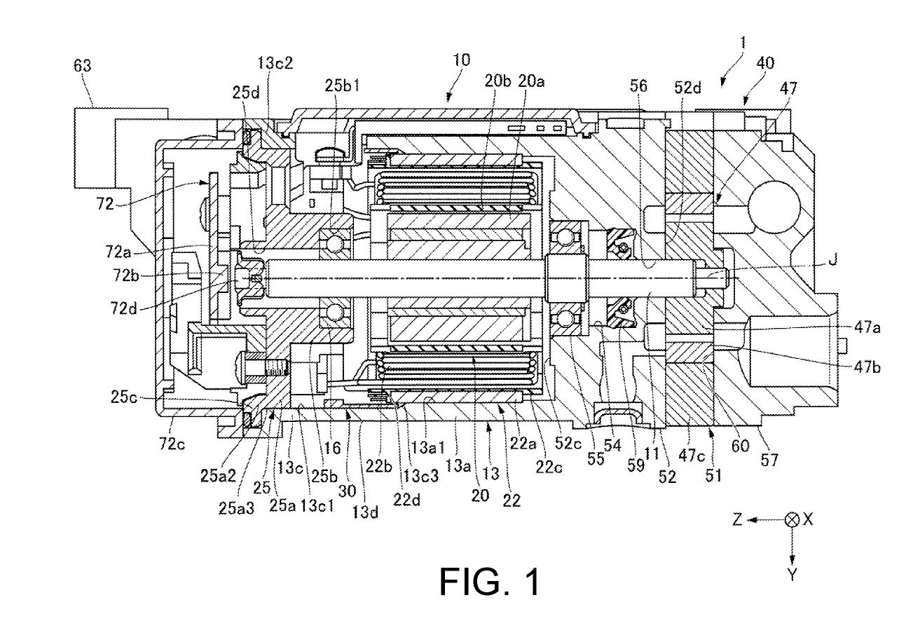

In addition, in the drawings, an XYZ coordinate system is appropriately shown as a three-dimensional orthogonal coordinate system. In the XYZ coordinate system, the Z axis direction is a direction parallel to an axial direction of a central axis J shown in FIG. 1 (a vertical direction in FIG. 1). The X axis direction is a direction parallel to a lateral direction of an electric oil pump shown in FIG. 1, that is, a direction orthogonal to the plane of the paper in FIG. 1. The Y axis direction is a direction orthogonal to both the X axis direction and the Z axis direction.

In addition, in the following description, the positive side (+Z side) in the Z axis direction will be referred to as “rear side” and the negative side (−Z side) in the Z axis direction will be referred to as “front side.” Here, the rear side and the front side are terms that are simply used for explanation, and do not limit actual positional relationships and directions. In addition, unless otherwise noted, a direction (Z axis direction) parallel to the central axis J is simply defined as an “axial direction,” a radial direction around the central axis J is simply defined as a “radial direction,” and a circumferential direction around the central axis J, that is, a circumference (0 direction) around the central axis J is simply defined as a “circumferential direction.”

Here, in this specification, the term “extending in the axial direction” includes not only extending strictly in the axial direction (the Z axial direction) but also extending in a direction inclined in a range of less than 45° with respect to the axial direction. In addition, in this specification, the term “extending in the radial direction” includes not only extending strictly in the radial direction, that is, extending in a direction perpendicular to the axial direction (the Z axial direction), but also extending in a direction inclined in a range of less than 45° with respect to the radial direction.

FIG. 1 is a cross-sectional view of an electric oil pump according to a first embodiment. FIG. 2 is a plan view of the electric oil pump in which illustration of a board cover is omitted. As shown in FIG. 1 and FIG. 2, an electric oil pump 1 of the present embodiment includes a motor part 10 and a pump part 40. In addition, the electric oil pump 1 includes a control part 82. The motor part 10 has a shaft 11 that is disposed along the central axis J that extends in the axial direction. The pump part 40 is positioned on one side (front side) of the motor part 10 in the axial direction and is driven by the motor part 10 via the shaft 11, and discharges oil. The control part 82 is disposed on the +X side with respect to the motor part 10 and controls an operation of the motor part 10. Constituent members will be described below in detail.

As shown in FIG. 1, the motor part 10 includes the shaft 11, a rotor 20, a stator 22, a cylindrical part 13d of a motor housing 13, and a coil 22b.

The motor part 10 is, for example, an inner rotor type motor, the rotor 20 is fixed to the outer circumferential surface of the shaft 11, and the stator 22 is disposed outside the rotor 20 in the radial direction. The rotor 20 is fixed to the other side (rear side) of the shaft 11 in the axial direction. The stator 22 is disposed to face the rotor 20.

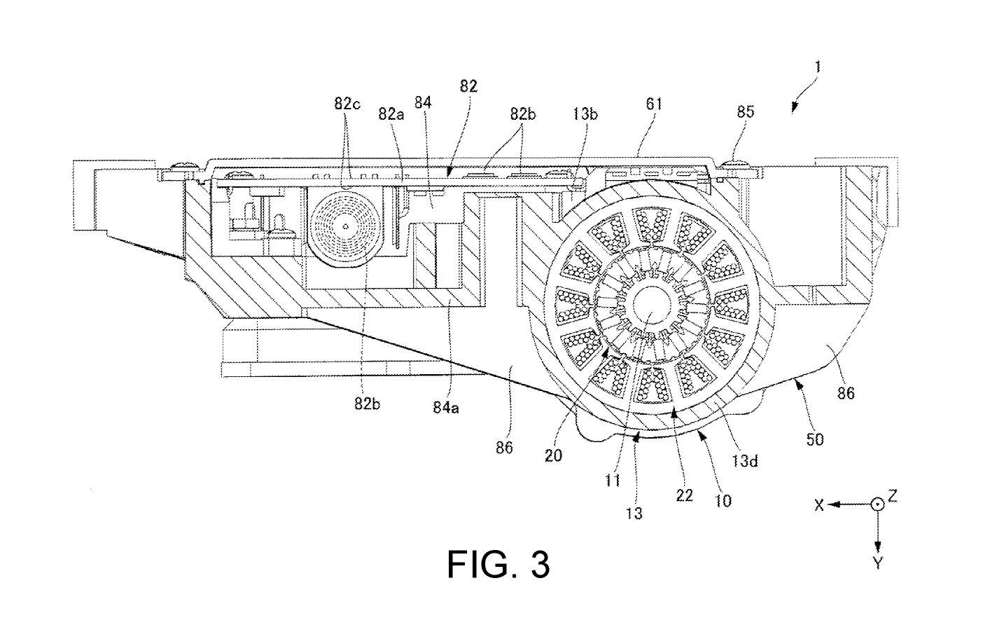

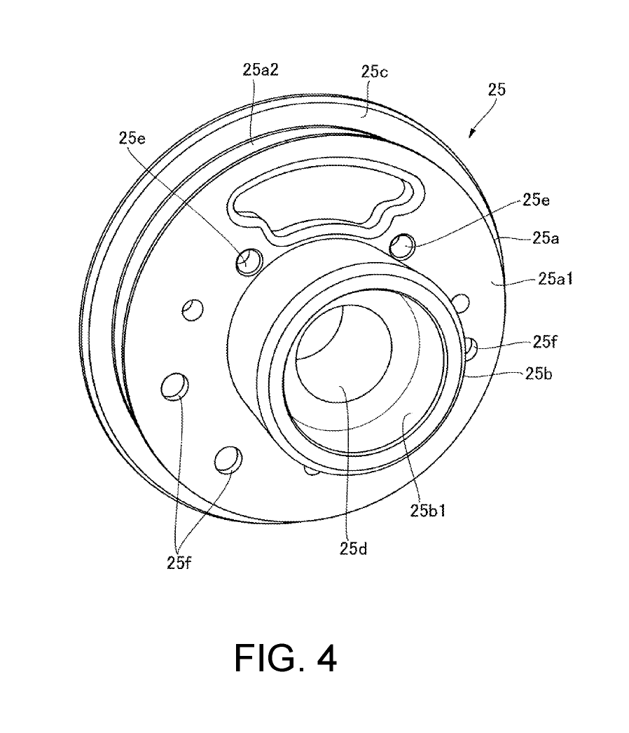

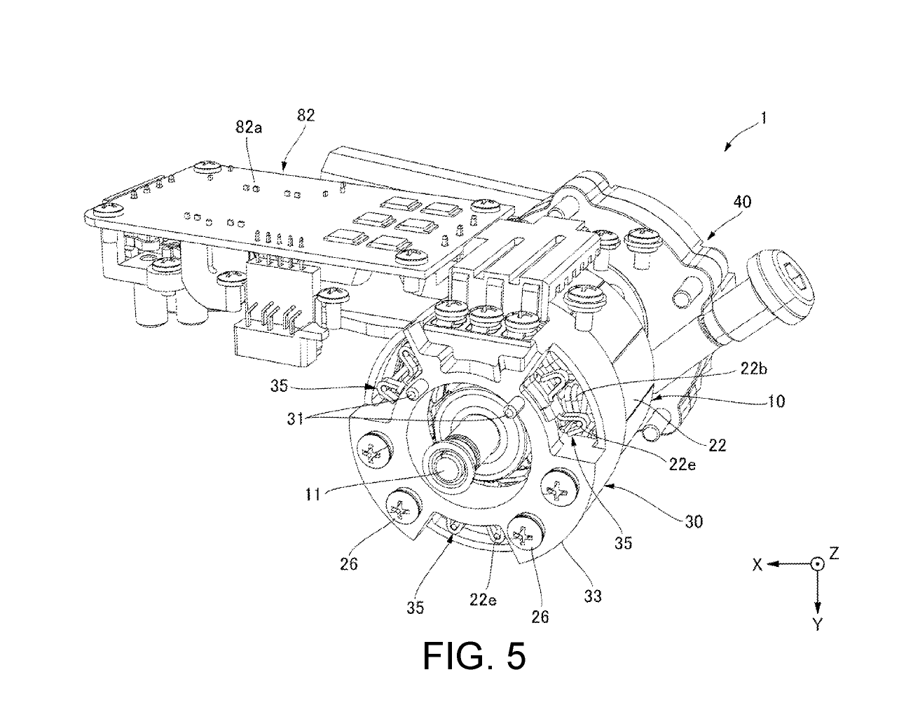

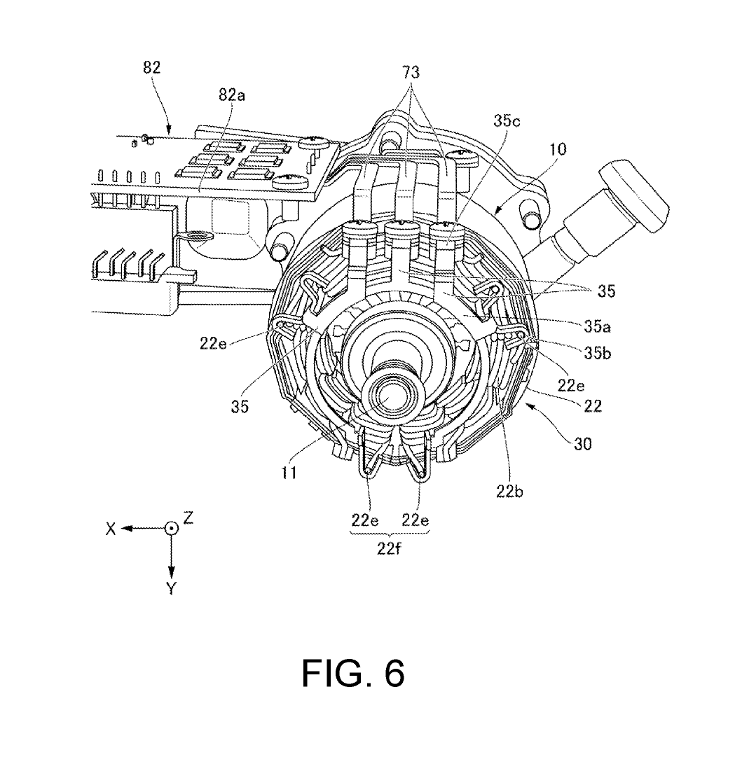

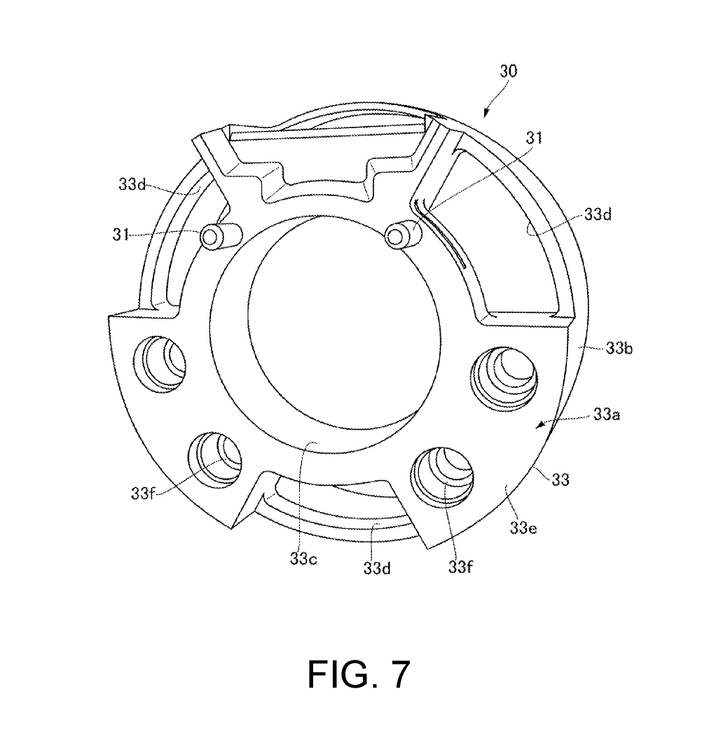

The motor housing 13 includes the cylindrical part 13d having a cylindrical shape that covers the stator 22 and a case 50 that extends in a direction orthogonal to the axial direction from the outer surface of the cylindrical part 13d. The rotor 20 and the stator 22 are accommodated in the cylindrical part 13d. The motor housing 13 includes a stator holding part 13a, a board support 13b (refer to FIG. 3), and a holding part 13c. The motor housing 13 is made of a metal. The cylindrical part 13d and the case 50 are integrally molded. Therefore, the cylindrical part 13d and the case 50 are a single member. A motor cover 72c is disposed at an end of the other side (rear side) of the cylindrical part 13d in the axial direction and an opening on the other side (rear side) of the cylindrical part 13d in the axial direction is covered with the motor cover 72c.

The stator holding part 13a has a cylindrical shape that extends in the axial direction. The shaft 11 of the motor part 10, the rotor 20, and the stator 22 are disposed in the stator holding part 13a. The outer surface of the stator 22, that is, the outer surface of a core back part 22a (to be described below), is fitted to an inner surface 13a1 of the stator holding part 13a. Thereby, the stator 22 is accommodated in the stator holding part 13a.

FIG. 3 is a cross-sectional view of the electric oil pump 1 taken along the arrow II-II in FIG. 2. As shown in FIG. 3, the board support 13b extends radially outward from the stator holding part 13a and supports a board 82a of the control part 82. The board support 13b is integrally molded with the case 50. Therefore, the board support 13b and the case 50 are a single member.

FIG. 4 is a perspective view of a bearing housing 25. As shown in FIG. 1, the holding part 13c is provided at the rear side end of the cylindrical part 13d of the motor housing 13. The bearing housing 25 is disposed at the rear side end of the cylindrical part 13d of the motor housing 13 which is on the inner side of the holding part 13c in the radial direction.

The bearing housing 25 has a tubular shape, and holds a bearing 16. The bearing 16 supports the shaft 11 that protrudes from the motor part 10 to the other side (rear side) in the axial direction. In the present embodiment, as shown in FIG. 4, the bearing housing 25 includes a disk-shaped main body part 25a, and a tubular bearing housing part 25b that protrudes from a front side surface (a front side end surface 25a1) of the main body part 25a to the front side. An annular raised part 25a2 that rises to the rear side is provided at the rear side end of the peripheral part of the main body part 25a. An outer surface 25a3 outside the raised part 25a2 in the radial direction is fitted to a surface 13c1 of the bearing holding part 13c. In the present embodiment, the outer surface 25a3 outside the raised part 25a2 in the radial direction is press-fitted to the inner surface 13c1 of the bearing holding part 13c.

A flange part 25c that protrudes radially outward is provided in an annular shape at the rear side end of the raised part 25a2. A front side surface of the flange part 25c comes in contact with a step 13c2 provided in the bearing holding part 13c. As shown in FIG. 1, in the step 13c2, the inner surface 13c1 on the rear side of the motor housing 13 bends and extends radially outward. Therefore, in the bearing housing 25, while the front side surface of the flange part 25c is in contact with the step 13c2, the outer surface 25a3 of the raised part 25a2 is press-fitted to the inner surface 13c1 of the bearing holding part 13c and fitted into the motor housing 13. Therefore, the bearing housing 25 that is positioned to the front side is fixed to the motor housing 13.

As shown in FIG. 1 and FIG. 4, the bearing housing part 25b has a concave part 25b1 in which the front side is open and the rear side is recessed. The concave part 25b1 has a circular shape when viewed from the front side. The bearing 16 is accommodated in the concave part 25b1. The concave part 25b1 is disposed coaxially with the central axis J of the shaft 11. The bearing 16 provided in the concave part 25b1 supports the rear side end of the shaft 11. A through-hole 25d that penetrates in the axial direction is provided at the central part of the bearing housing 25. The through-hole 25d is smaller than the inner diameter of the concave part 25b1. In the through-hole 25d, the front side opens to the concave part 25b1 and the rear side opens to the rear side surface of the main body part 25a. The inner diameter of the through-hole 25d is larger than the outer diameter of the shaft 11.

FIG. 5 is a perspective view of an internal structure of the electric oil pump 1 when viewed from the side of the motor part 10. As shown in FIG. 4, in the main body part 25a of the bearing housing 25, a plurality of fixing through-holes 25f through which a fixing member 26 passes is provided outside the bearing housing part 25b in the radial direction. In the present embodiment, two fixing through-holes 25f are provided at symmetrical positions on both sides of the bearing housing part 25b in the radial direction (X axis direction) and penetrate in the axial direction. In addition, in the main body part 25a, two positioning holes 25e through which a positioning pin 31 provided in a bus bar assembly 30 passes are provided to penetrate in the axial direction. In the present embodiment, the two positioning holes 25e are provided at positions close to the bearing housing part 25b on the −Y side of the bearing housing part 25b.

FIG. 6 is an internal structure view of the bus bar assembly 30 in which an assembly main body 33 is omitted. FIG. 7 is a perspective view of the assembly main body 33 of the bus bar assembly 30. As shown in FIG. 5 and FIG. 6, the bus bar assembly 30 is connected to a coil end 22e of the coil 22b that extends from the stator 22. In addition, the bus bar assembly 30 is connected to a bus bar 73 connected to the board 82a. Therefore, the coil end 22e is electrically connected to the board 82a through the bus bar assembly 30.

The bus bar assembly 30 has a tubular shape, and includes a plurality of connecting bus bars 35 connected to the coil end 22e and the assembly main body 33 in which the connecting bus bar 35 is disposed. In the present embodiment, the connecting bus bar 35 is made of a metal, and the bus bar assembly 30 is an integrally molded article made of a resin.

The coil end 22e protrudes from an end on the other side (rear side) of the motor part 10 in the axial direction. When two coil ends 22e adjacent in the circumferential direction are set as one coil end group 22f, three coil end groups 22f are disposed at uniform intervals in the circumferential direction. Therefore, the bus bar assembly 30 has three connecting bus bars 35 connected to the respective three coil end groups 22f.

The connecting bus bar 35 includes a bus bar main body part 35a that is curved in the circumferential direction radially outward from the shaft 11, a coil end side connection part 35b connected to one end of the bus bar main body part 35a and connected to the coil end 22e, and a board side connection part 35c connected to the other end of the bus bar main body part 35a and connected to the bus bar 73 connected to the board 82a.

As shown in FIG. 7, the assembly main body 33 has a tubular shape and has one side (front side) in the axial direction that is open and a bottom 33a on the rear side. The assembly main body 33 has the bottom 33a at the rear side end of a tubular part 33b that extends in a cylindrical shape. An insertion hole 33c into which the bearing housing part 25b of the bearing housing 25 is inserted is provided at the central part of the bottom 33a. The bus bar assembly 30 is disposed on the inner surface 13a1 of the motor housing 13 in the axial direction in a freely movable manner. In the present embodiment, the outer diameter of the tubular part 33b is smaller than the inner diameter of the inner surface 13a1 of the motor housing 13.

As shown in FIG. 1, a step 13c3 protruding radially inward is provided on the inner surface 13a1 of the motor housing 13. One side end of the bus bar assembly 30 in the axial direction comes in contact with the step 13c3 and the bus bar assembly 30 is disposed in the motor housing 13. In the present embodiment, as shown in FIG. 1, the step 13c3 is provided at a position at which the inner surface 13a1 of the motor housing 13 forming the stator holding part 13a is connected to the inner surface 13c1 of the motor housing 13 forming the bearing holding part 13c. The inner diameter of the inner surface 13a1 of the stator holding part 13a is smaller than the inner diameter of the inner surface 13c1 of the bearing holding part 13c. Therefore, the step 13c3 is provided at a position at which the inner surface 13a1 of the stator holding part 13a is connected to the inner surface 13c1 of the bearing holding part 13c. The step 13c3 is positioned at a position slightly shifted to the front side from the rear side end of the stator 22.

At the step 13c3, the front side end of the tubular part 33b of the bus bar assembly 30 comes in contact with the step 13c3 and is disposed in the motor housing 13. Therefore, positioning of the bus bar assembly 30 on the front side can be performed. In addition, in the tubular part 33b, while the front side end is in contact with the step 13c3, the outer surface of the tubular part 33b comes in contact with the inner surface of the cylindrical part 13d of the motor housing 13, and is disposed in the motor housing 13 in contact with the outside of the stator 22. Therefore, it is possible to position a bus bar assembly 13 in the radial direction with respect to the inside of the motor housing 13. Here, during positioning of the bus bar assembly 13 in the radial direction, the tubular part 33b of the bus bar assembly 30 may come in contact with only one of the inner surface of the cylindrical part 13d of the motor housing 13 and the outer surface of the stator 22. In addition, on the other side with respect to the step 13c3 in the axial direction, the stator 22, the tubular part 33b of the bus bar assembly 30, and the cylindrical part 13d of the motor housing 13 are sequentially disposed in contact from the inner side to the outer side in the radial direction. Therefore, it is possible to easily position the bus bar assembly 30 in the radial direction with respect to the motor housing 13.

As shown in FIG. 5 and FIG. 7, the bus bar assembly 30 has a plurality of exposure through-holes 33d which are provided at intervals in the circumferential direction of the peripheral part in the bus bar assembly 30 and to which the coil end side connection part 35b of the connecting bus bar 35 is exposed when viewed in the axial direction. In the present embodiment, the exposure through-holes 33d are provided at positions at uniform intervals in the circumferential direction of the peripheral part of the bottom 33a of the bus bar assembly 30. The exposure through-hole 33d is an elongated hole that is curved and extends in the circumferential direction when viewed from the rear side.

The bus bar assembly 30 has a rear side end surface 33e that comes in contact with the front side end surface 25a1 on one side of the bearing housing 25 in the axial direction at the other side end in the axial direction. In the present embodiment, the rear side end surface 33e is a rear side surface of the bottom 33a of the assembly main body 33. The rear side end surface 33e has a female screw 33f into which a shaft part of the fixing member 26 (bolt) inserted into the bearing housing 25 is screwed between the pair of exposure through-holes 33d adjacent in the circumferential direction of the bus bar assembly 30. In the present embodiment, as shown in FIG. 7, two female screws 33f are provided with an interval therebetween in the circumferential direction on the rear side end surface 33e on both sides in the X axis direction of the insertion hole 33c provided at the central part of the assembly main body 33. The female screw 33f has an insert.

Two positioning pins 31 that protrude to the other side in the axial direction in an area of the rear side end surface 33e different from an area in which the female screws 33f are provided and are disposed with an interval therebetween are provided on the rear side end surface 33e of the bus bar assembly 30. In the present embodiment, the two positioning pins 31 are provided on the side of −Y axis direction with respect to the female screw 33f.

The bus bar assembly 30 is fixed to the bearing housing 25 through the fixing member 26 (bolt). In the present embodiment, in the bus bar assembly 30, while the front side end surface 25a1 of the bearing housing 25 comes in contact with the rear side end surface 33e of the bus bar assembly 30 and the positioning pin 31 is inserted into the positioning hole 25e, the fixing member 26 (bolt) inserted into the fixing through-hole 25f of the bearing housing 25 is screwed into the female screw 33f of the bus bar assembly 30, and thus the bus bar assembly 30 is fixed to the bearing housing 25. In the present embodiment, the fixing member 26 is a bolt.

As shown in FIG. 1, the rotor 20 is fixed to the rear side of the shaft 11 with respect to the pump part 40. The rotor 20 includes a rotor core 20a and a rotor magnet 20b. The rotor core 20a surrounds a circumference (0 direction) around the shaft 11 and is fixed to the shaft 11. The rotor magnet 20b is fixed to the outer surface along a circumference (0 direction) around the rotor core 20a. The rotor core 20a and the rotor magnet 20b rotate together with the shaft 11. Here, the rotor 20 may be an embedded magnet type in which a permanent magnet is embedded inside the rotor 20. Compared to a surface magnet type in which a permanent magnet is provided on the surface of the rotor 20, in the embedded magnet type rotor 20, it is possible to reduce a risk of the magnet being peeled off due to a centrifugal force, and it is possible to actively use a reluctance torque.

The stator 22 is disposed to face the rotor 20 outside the rotor 20 in the radial direction and surrounds a circumference (0 direction) around the rotor 20 and rotates the rotor 20 around the central axis J. The stator 22 includes the core back part 22a, a tooth part 22c, a coil 22b, and an insulator (bobbin) 22d.

The shape of the core back part 22a is a cylindrical shape concentric with the shaft 11. The tooth part 22c extends from the inner surface of the core back part 22a toward the shaft 11. A plurality of tooth parts 22c are provided and are disposed at uniform intervals in the circumferential direction on the inner surface of the core back part 22a. The coil 22b is wound around the insulator 22d. The insulator 22d is attached to each of the tooth parts 22c.

As shown in FIG. 1, the shaft 11 extends around the central axis J that extends in the axial direction and penetrates the motor part 10. The front side (−Z side) of the shaft 11 protrudes from the motor part 10 and extends into the pump part 40. The front side of the shaft 11 is fixed to an inner rotor 47a of the pump part 40. The front side of the shaft 11 is supported by a bearing 55 (to be described below). Therefore, the shaft 11 is supported at both ends.

As shown in FIG. 3, the control part 82 includes the board 82a and a plurality of electronic components 82b mounted on the board 82a. The control part 82 generates a signal for driving the motor part 10 and outputs the signal to the motor part 10. The board 82a is supported by and fixed to the board support 13b that extends radially outward from the motor housing 13.

Here, as shown in FIG. 1, a rotation angle sensor 72b configured to detect a rotation angle of the shaft 11 is disposed at a position inside the motor cover 72c which faces the rear side end of the shaft 11. The rotation angle sensor 72b is mounted on a circuit board 72a. The circuit board 72a is supported by and fixed to a board support (not shown) fixed to the rear side end of the motor housing 13. A magnet for a rotation angle sensor 72d is disposed at and fixed to the rear side end of the shaft 11. The rotation angle sensor 72b faces the magnet for a rotation angle sensor 72d and is disposed on the rear side of the magnet for a rotation angle sensor 72d. When the shaft 11 rotates, the magnet for a rotation angle sensor 72d also rotates and thereby a magnetic flux changes. The rotation angle sensor 72b detects a change in the magnetic flux due to rotation of the magnet for a rotation angle sensor 72d and thereby detects a rotation angle of the shaft 11.

As shown in FIG. 1, the pump part 40 is positioned on one side (front side) of the motor part 10 in the axial direction. The pump part 40 is driven by the motor part 10 via the shaft 11. The pump part 40 includes a pump rotor 47 and a pump housing 51. In the present embodiment, the pump housing 51 includes a pump body 52 and a pump cover 57. The pump housing 51 has a housing part 60 for accommodating the pump rotor 47 between the pump body 52 and the pump cover 57. These components will be described below in detail.

As shown in FIG. 1, the pump body 52 is positioned at the front side end of the motor housing 13. The pump body 52 has a concave part 54 that is recessed from an end surface 52c on the rear side (+Z side) to the front side (−Z side). The bearing 55 and a sealing member 59 are sequentially accommodated in the concave part 54 from the rear side to the front side. The bearing 55 supports the shaft 11 that protrudes from the motor part 10 to one side (front side) in the axial direction. The sealing member 59 seals oil leaking from the pump rotor 47.

The pump body 52 has a through-hole 56 that penetrates along the central axis J. Both ends of the through-hole 56 in the axial direction are open and the shaft 11 passes therethrough, and an opening on the rear side (+Z side) opens to the concave part 54 and an opening on the front side (−Z side) opens to an end surface 52d on the front side of the pump body 52.

As shown in FIG. 1, the pump rotor 47 is attached to the front side of the shaft 11. The pump rotor 47 includes the inner rotor 47a, an outer rotor 47b, and a rotor body 47c. The pump rotor 47 is attached to the shaft 11. More specifically, the pump rotor 47 is attached to the front side (−Z side) of the shaft 11. The inner rotor 47a is fixed to the shaft 11. The outer rotor 47b surrounds the outside of the inner rotor 47a in the radial direction. The rotor body 47c surrounds the outside of the outer rotor 47b in the radial direction. The rotor body 47c is fixed to the pump body 52.

The inner rotor 47a has an annular shape. The inner rotor 47a is a gear having teeth on the outer surface in the radial direction. The inner rotor 47a rotates around a circumference (θ direction) together with the shaft 11. The outer rotor 47b has an annular shape surrounding the outside of the inner rotor 47a in the radial direction. The outer rotor 47b is a gear having teeth on the inner surface in the radial direction. The outer surface of the outer rotor 47b in the radial direction has a circular shape. The inner surface of the rotor body 47c in the radial direction has a circular shape.

The gear on the outer surface of the inner rotor 47a in the radial direction is engaged with the gear on the inner surface of the outer rotor 47b in the radial direction, and the outer rotor 47b is rotated according to rotation of the inner rotor 47a by the shaft 11. That is, the pump rotor 47 rotates according to rotation of the shaft 11. In other words, the motor part 10 and the pump part 40 have the same rotation axis. Thereby, it is possible to prevent the size of the electric oil pump 1 from becoming larger in the axial direction.

In addition, when the inner rotor 47a and the outer rotor 47b rotate, a volume between engaging parts of the inner rotor 47a and the outer rotor 47b changes. An area in which the volume decreases is a pressurized area and an area in which the volume increases is a negative pressure area. An intake port (not shown) of the pump cover 57 is disposed on the front side of the negative pressure area of the pump rotor 47. In addition, a discharge port of the pump cover 57 (not shown) is disposed on the front side of a pressurized area of the pump rotor 47.

As shown in FIG. 1, the pump cover 57 is attached to the front side of the pump rotor 47. The pump cover 57 is fixed to the rotor body 47c of the pump rotor 47. The pump cover 57 is attached and fixed to the pump body 52 together with the rotor body 47c of the pump rotor 47. The pump cover 57 has an intake opening 41 (refer to FIG. 2) connected to the intake port. The pump cover 57 has a discharge opening 42 (refer to FIG. 2) connected to the discharge port.

Oil sucked into the pump rotor 47 from the intake opening 41 provided at the pump cover 57 through the intake port of the pump cover 57 is stored in a volume part between the inner rotor 47a and the outer rotor 47b and is sent to the pressurized area. Then, the oil is discharged from the discharge opening 42 provided at the pump cover 57 through the discharge port of the pump cover 57. A direction in which the intake opening 41 is sucked is orthogonal to a direction in which oil is discharged from the discharge opening 42. Thereby, it is possible to reduce a pressure loss from the intake opening to the discharge opening and it is possible to make a flow of oil smooth.

As shown in FIG. 2, the intake opening 41 is disposed on the side in which the board 82a is disposed with respect to the motor part 10. Thereby, an additionally required disposition space is minimized by arranging a disposition space of the intake opening 41 and a disposition space of the board 82a in an overlapping manner and it is possible to reduce the size of the electric oil pump 1 in the radial direction.

As shown in FIG. 2 and FIG. 3, the case 50 has a board housing part 84 that extends from the motor housing 13 in a direction (+X direction) orthogonal to the axial direction and is recessed to the positive side in the Y axis direction. In addition, the board housing part 84 extends from one side end of the motor housing 13 in the axial direction to the other side end.

The board housing part 84 has a bottomed container shape and has a rectangular shape when viewed toward the positive side in the Y axis direction. The board 82a is accommodated in the board housing part 84. Thereby, it is possible to reduce the size of the electric oil pump 1 in the direction (Y axis direction) orthogonal to the axial direction.

As shown in FIG. 2, the electric oil pump 1 is attached to an attachment surface provided on a bottom surface of a transmission (not shown). The electric oil pump 1 is accommodated in an oil pan provided below the transmission. The electric oil pump 1 sucks oil in the oil pan from the intake opening 41 and discharges it from the discharge opening 42. The case 50 of the electric oil pump 1 has a plurality of attachment parts 63 attached to the attachment surface of the transmission. In the present embodiment, the attachment part 63 is provided at the tip of an arm 50a that extends obliquely outward from corners on both sides in the axial direction of the negative side end of the board housing part 84 in the Y axis direction when viewed toward the positive side in the X axis direction. In addition, the attachment part 63 is provided at the tip of an arm 50b that extends obliquely outward from each of both sides in the axial direction of the outer surface of the motor housing 13 opposite to the side on which the board housing part 84 is positioned with respect to the motor housing 13.

The attachment part 63 has an attachment through-hole 64 at the center. A bolt (not shown) passes through the attachment through-hole 64 and the electric oil pump 1 is attached to an attachment surface of the transmission using the bolt. The attachment part 63 has a contact surface that comes in contact with the attachment surface when the electric oil pump 1 is attached to the attachment surface.

As shown in FIG. 3, the case 50 has a fin part 80 that extends in the X axis direction on the outer surface on the positive side of the motor housing 13 in the Y axis direction opposite to the side on which the board housing part 84 is positioned with respect to the motor housing 13. The fin part 80 dissipates heat generated from the electric oil pump 1. In addition, as shown in the drawing, the board housing part 84 has a plurality of heat dissipating fins 86 that protrude in the Y axis direction on a bottom 84a of the board housing part 84 and extend in the X axis direction. The plurality of heat dissipating fins 86 are disposed at intervals in the axial direction. The heat dissipating fin 86 dissipates heat generated from the board 82a and the motor part 10.

Next, a method of producing the electric oil pump 1 will be described with reference to FIG. 1. The method of producing the electric oil pump 1 includes a stator press-fitting process in which the stator 22 is press-fitted into the motor housing 13 from the other side of the motor housing 13 in the axial direction, a bus bar assembly insertion process in which the bus bar assembly 30 is inserted into the motor housing 13 from the other side of the motor housing 13 in the axial direction and the bus bar assembly 30 is disposed near the stator 22, a coil connection process in which the coil end 22e of the coil 22b is electrically connected to the connecting bus bar 35 of the bus bar assembly 30, a bearing housing press-fitting process in which the bearing housing 25 is press-fitted into the motor housing 13 from the other side of the motor housing 13 in the axial direction, and a bus bar assembly fixing process in which the bus bar assembly 30 is fixed to the bearing housing 25 through the fixing member 26.

In the stator press-fitting process of the present embodiment, the stator 22 is press-fitted and fixed to the inner surface 13a1 of the motor housing 13 which is the stator holding part 13a of the motor housing 13. In the bus bar assembly insertion process, the bus bar assembly 30 is inserted along the inner surface 13a1 of the motor housing 13 which is the bearing holding part 13c of the motor housing 13, and the assembly main body 33 of the bus bar assembly 30 is brought into contact with the step 13c3. In the coil connection process, the coil end 22e is connected to the coil end side connection part 35b of the connecting bus bar 35 by welding or fusing. In the bus bar assembly fixing process, the fixing member 26 (bolt) is inserted into the fixing through-hole 25f of the bearing housing 25 and screwed into the female screw 33f of the bus bar assembly 30.

After the bus bar assembly fixing process, a rotation angle sensor assembly fixing process in which a rotation angle sensor assembly 72 to which the rotation angle sensor 72b capable of detecting a rotation angle of the shaft 11 is attached is fixed to the bearing housing 25 through the fixing member 26 is performed. In the present embodiment, the fixing member 26 is a bolt. As shown in FIG. 1, the rotation angle sensor assembly 72 includes the rotation angle sensor 72b and the circuit board 72a attached to the rotation angle sensor 72b. The rotation angle sensor assembly fixing process includes a rotation angle sensor attaching process in which the rotation angle sensor 72b is attached to the circuit board 72a. When the rotation angle sensor attaching process is performed, it is possible to obtain the rotation angle sensor assembly 72 in which the rotation angle sensor 72b is attached to the circuit board 72a through the fixing member 26 (bolt).

Next, actions and effects of the electric oil pump 1 will be described. As shown in FIG. 1 and FIG. 2, when the motor part 10 of the electric oil pump 1 is driven, the shaft 11 of the motor part 10 rotates, and the outer rotor 47b also rotates as the inner rotor 47a of the pump rotor 47 rotates. When the pump rotor 47 rotates, oil sucked from the intake opening 41 of the pump part 40 moves into the housing part 60 of the pump part 40, and is discharged from the discharge opening 42.

(1) Here, as shown in FIG. 1, in the electric oil pump 1 according to the present embodiment, from the pump part 40 to the motor part 10, the stator 22, the bus bar assembly 30, and the bearing housing 25 are sequentially disposed. Therefore, a control part configured to control an operation of the motor part 10 is not provided on the other side with respect to the bearing housing 25 in the axial direction. Thus, compared to when a control part is disposed on the other side of the shaft 11 in the axial direction, the length of the electric oil pump 1 in the axial direction can be shortened and it is possible to reduce the size of the electric oil pump.

(2) In addition, the bearing housing 25 is disposed in the motor housing 13 and is fixed to the inner surface 13c1 of the motor housing 13. Therefore, in the bearing housing 25, a component for fixing into the motor housing 13 is not necessary. Thus, it is possible to reduce the cost of the electric oil pump 1.

(3) In addition, the bus bar assembly 30 is disposed on the inner surface 13a1 of the motor housing 13 in the axial direction in a freely movable manner. Therefore, the bus bar assembly 30 can be easily inserted and disposed into a motor housing 13c1.

(4) The tubular part 33b of the bus bar assembly 30 is disposed between the stator 22 and the cylindrical part 13d of the motor housing 13, and the tubular part 33b comes in contact with at least one of the outer circumferential surface of the stator 22 and the inner circumferential surface of the cylindrical part 13d. Therefore, it is possible to easily position the bus bar assembly 30 in the radial direction with respect to the motor housing 13.

(5) In addition, one side end of the bus bar assembly 30 in the axial direction comes in contact with the step 13c3 and the bus bar assembly 30 is disposed in the motor housing 13. Therefore, it is possible to easily perform positioning on one side of the bus bar assembly 30 in the axial direction.

(6) In addition, the bus bar assembly 30 has a plurality of exposure through-holes 33d which are provided at intervals in the circumferential direction of the peripheral part in the bus bar assembly 30 and to which the coil end side connection part 35b of the connecting bus bar 35 is exposed when viewed in the axial direction. Therefore, when the coil end 22e is connected to the coil end side connection part 35b, it is possible to easily connect the coil end 22e to the coil end side connection part 35b through the exposure through-hole 33d.

(7) In addition, the female screw 33f into which a shaft part of the fixing member 26 (bolt) inserted into the bearing housing 25 is screwed is provided on the rear side end surface 33e between the pair of exposure through-holes 33d adjacent in the circumferential direction of the bus bar assembly 30 within the rear side end surface 33e of the bus bar assembly 30. Therefore, since the fixing member 26 (bolt) is fastened to the female screw 33f while the rear side end surface 33e of the bus bar assembly 30 is in contact with the front side end surface 25a1 of the bearing housing 25, the bus bar assembly 30 can be firmly fixed to the bearing housing 25.

(8) In addition, on the rear side end surface 33e of the bus bar assembly 30, two positioning pins 31 that protrude to the other side in the axial direction on an area of the rear side end surface 33e different from an area in which the female screw 33f is provided are disposed at an interval therebetween are provided. In addition, the bearing housing 25 has the positioning hole 25e into which two positioning pins 31 are inserted on the front side end surface 25a1. Therefore, when the two positioning pins 31 are inserted into the positioning hole 25e, it is possible to perform positioning in the circumferential direction and the radial direction of the bus bar assembly 30.

(9) In addition, the bus bar assembly 30 is an integrally molded article made of a resin. Therefore, it is possible to increase the position accuracy of a component (for example, the connecting bus bar 35) disposed in the bus bar assembly 30.

(10) In addition, the bearing housing 25 is press-fitted and fixed to the inner surface 13c1 of the motor housing 13. Therefore, the bearing housing 25 can be firmly fixed to the motor housing 13.

(11) In addition, the bus bar assembly 30 is fixed to the bearing housing 25 through the fixing member 26. Therefore, the bus bar assembly 30 can be fixed to the bearing housing 25.

(12) In addition, the fixing member 26 is a bolt. Therefore, the bus bar assembly 30 can be firmly fixed to the bearing housing 25.

(13) In addition, a stator press-fitting process, a bus bar assembly insertion process, a coil connection process, a bearing holding part press-fitting process, and a bus bar assembly fixing process are included. Therefore, it is possible to provide a method of producing the electric oil pump 1 through which the bus bar assembly 30 can be firmly fixed to the bearing housing 25 through the fixing member 26 according to these processes.

(14) In addition, after the bus bar assembly fixing process, the rotation angle sensor assembly fixing process is performed. Therefore, it is possible to provide a method of producing the electric oil pump 1 through which it is possible to provide the rotation angle sensor assembly 72 to the electric oil pump 1.

(15) In addition, the rotation angle sensor assembly fixing process includes a rotation angle sensor attaching process in which the rotation angle sensor 72b is attached to the circuit board 72a through the fixing member 26. Therefore, when the rotation angle sensor attaching process is performed, it is possible to obtain the rotation angle sensor assembly 72 in which the rotation angle sensor 72b is attached to the circuit board 72a through the fixing member 26.

(16) In addition, since the fixing member 26 is a bolt, the bus bar assembly 30 can be firmly fixed to the bearing housing 25 in the bus bar assembly fixing process. In addition, in the rotation angle sensor attaching process, the rotation angle sensor 72b can be firmly fixed to the circuit board 72a.

While the exemplary embodiments of the disclosure have been described above, the disclosure is not limited to such embodiments and various modifications and alternations within the spirit and scope of the disclosure can be made. These embodiments and modifications thereof are included in the scope and spirit of the disclosure and also included in the scope described in the claims and equivalents thereof.

Features of the above-described exemplary embodiments and the modifications thereof may be combined appropriately as long as no conflict arises.

While the exemplary embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An electric oil pump comprising:
a motor part having a shaft disposed along a central axis that extends in an axial direction; and
a pump part that is positioned on one side of the motor part in the axial direction and is driven by the motor part via the shaft and discharges oil,
wherein the motor part includes a rotor fixed to the other side of the shaft in the axial direction, a stator disposed to face the rotor, a coil provided in the stator, and a motor housing having a cylindrical part in which the rotor and the stator are accommodated,
wherein the pump part includes a pump rotor attached to the shaft that protrudes from the motor part to one side in the axial direction and a pump housing having a housing part in which the pump rotor is accommodated,
wherein the motor housing includes a bearing that supports the shaft that protrudes from the motor part to the other side in the axial direction, a tubular bearing housing that holds the bearing, and a bus bar assembly connected to a coil end of the coil that extends from the stator, and
wherein the stator, the bus bar assembly, and the bearing housing are sequentially disposed from the pump part to the motor part.

2. The electric oil pump according to claim 1,
wherein the motor housing has a tubular shape and
wherein the bearing housing is disposed in the motor housing and fixed to an inner surface of the motor housing.

3. The electric oil pump according to claim 2,
wherein the bus bar assembly has a tubular part having a tubular shape and the bus bar assembly is disposed on the inner surface of the motor housing in the axial direction in a freely movable manner.

4. The electric oil pump according to claim 3,
wherein the tubular part of the bus bar assembly is disposed between the stator and the cylindrical part of the motor housing, and the tubular part comes in contact with at least one of an outer circumferential surface of the stator and an inner circumferential surface of the cylindrical part.

5. The electric oil pump according to claim 3,
wherein a step that protrudes radially inward is provided on the inner surface of the motor housing, and
wherein one side end of the tubular part of the bus bar assembly in the axial direction comes in contact with the step and the bus bar assembly is disposed in the motor housing.

6. The electric oil pump according to claim 4,
wherein the bus bar assembly has a plurality of connecting bus bars connected to the coil end of the coil that extends from the stator,
wherein the connecting bus bars have coil end side connection parts connected to the coil end,
wherein the coil end side connection parts are disposed at intervals in a circumferential direction of a peripheral part in the bus bar assembly,
wherein the bus bar assembly is provided with the intervals in the circumferential direction of the peripheral part in the bus bar assembly, and
wherein the coil end side connection parts of the connecting bus bars have a plurality of exposure through-holes that are exposed when viewed in the axial direction.

7. The electric oil pump according to claim 6,
wherein the bus bar assembly has a rear side end surface that comes in contact with a front side end surface on one side of the bearing housing in the axial direction at the other side end in the axial direction, and
wherein the rear side end surface of the bus bar assembly has a female screw into which a shaft part of the bolt inserted into the bearing housing is screwed on the rear side end surface between the pair of exposure through-holes adjacent in the circumferential direction of the bus bar assembly.

8. The electric oil pump according to claim 7,
wherein two positioning pins that protrude to the other side in the axial direction on an area of the rear side end surface different from an area in which the female screw is provided and disposed at an interval therebetween are provided on the rear side end surface of the bus bar assembly, and
wherein the bearing housing has a positioning hole into which the two positioning pins are inserted on the front side end surface.

9. The electric oil pump according to claim 6,
wherein the bus bar assembly is an integrally molded article made of a resin.

10. The electric oil pump according to claim 2,
wherein the bearing housing is press-fitted and fixed to an inner surface of the motor housing.

11. The electric oil pump according to claim 4,
wherein the bus bar assembly is fixed to the bearing housing through a fixing member.

12. The electric oil pump according to claim 11,
wherein the fixing member is a bolt.

13. A method of producing an electric oil pump which includes a motor part having a shaft disposed along a central axis that extends in an axial direction; and a pump part that is positioned on one side of the motor part in the axial direction and is driven by the motor part via the shaft and discharges oil, and in which the motor part includes a rotor fixed to the other side of the shaft in the axial direction, a stator disposed to face the rotor, a coil provided in the stator, and a motor housing in which the rotor and the stator are accommodated, in which the motor housing includes a bearing that supports the shaft that protrudes from the motor part to the other side in the axial direction, a tubular bearing housing that holds the bearing, and a bus bar assembly connected to a coil end of the coil that extends from the stator, the method comprising:
a stator press-fitting process in which the stator is press-fitted into the motor housing from the other side of the motor housing in the axial direction;
a bus bar assembly insertion process in which the bus bar assembly is inserted into the motor housing from the other side of the motor housing in the axial direction and the bus bar assembly is disposed near the stator;
a coil connection process in which a coil end of the coil is electrically connected to a connecting bus bar of the bus bar assembly;
a bearing housing press-fitting process in which the bearing housing is press-fitted into the motor housing from the other side of the motor housing in the axial direction; and
a bus bar assembly fixing process in which the bearing housing is fixed to the bus bar assembly through a fixing member.

14. The method of producing an electric oil pump according to claim 13, comprising
a rotation angle sensor assembly fixing process in which a rotation angle sensor assembly to which a rotation angle sensor capable of detecting a rotation angle of the shaft is attached is fixed to the bearing housing through the fixing member after the bus bar assembly fixing process.

15. The method of producing an electric oil pump according to claim 14,
wherein the rotation angle sensor assembly includes the rotation angle sensor and a circuit board to which the rotation angle sensor is attached, and
wherein the rotation angle sensor assembly fixing process includes a rotation angle sensor attaching process in which the rotation angle sensor is attached to the circuit board.

16. The method of producing an electric oil pump according to claim 13,
wherein the fixing member is a bolt.
